(19) United States
(12) Patent Application Publication
(10) Pub. No.: US 2018/0124080 A1
(43) Pub. Date: May 3, 2018

(54) Methods and Systems for Anomaly Detection Using Functional Specifications Derived from Server Input/Output (I/O) Behavior

(71) Applicant: QUALCOMM Incorporated, San Diego, CA (US)

(72) Inventors: Mihai Christodorescu, San Jose, CA (US); Nayeem Islam, Palo Alto, CA (US); Arun Raman, San Francisco, CA (US); Shuhua Ge, Fremont, CA (US)

(21) Appl. No.: 15/455,774

(22) Filed: Mar. 10, 2017

Related U.S. Application Data
(60) Provisional application No. 62/416,384, filed on Nov. 2, 2016.

(51) Int. Cl. H04L 29/06

(52) U.S. Cl. CPC H04L 63/1425

(57) ABSTRACT

Various embodiments include methods of protecting a computing device within a network from malware or other non-benign behaviors. A computing device may monitor inputs and outputs to a server, derive a functional specification from the monitored inputs and outputs, and use the functional specification for anomaly detection. Use of the derived functional specification for anomaly detection may include determining whether a behavior, activity, web application, process or software application program is non-benign. The computing device may be the server, and the functional specification may be used to determine whether the server is under attack. In some embodiments, the computing device may constrain the functional specification with a generic constraint, detect a new input-output pair, determine whether the detected input-output pair satisfies the constrained functional specification, and determine that the detected input-output pair is anomalous upon determining that the detected input-output pair (or request-response pair) satisfies the constrained functional specification.

### RELATED APPLICATIONS

This application claims the benefit of priority to U.S. Provisional Application No. 62/416,384, entitled “Methods and Systems for Anomaly Detection Using Functional Specifications Derived from Server Input/Output (I/O) Behavior” filed Nov. 2, 2016, the entire contents of which are hereby incorporated by reference.

### BACKGROUND

A recent trend in computing technologies involves moving the storage and execution of application software from client devices to server computing devices, which may be deployed in a cloud communication network that enables ubiquitous, on-demand access to a shared pool of commodity hardware and other computing resources. Such server computing devices (sometimes known as “application servers”) receive inputs (e.g., data inputs, function requests, etc.) from client devices via high-speed communication links, apply the received inputs to application software to execute various routines, capture the outputs generated via the execution of the routines, and send the captured outputs back to the respective client devices. The client devices may receive and use this information (i.e., the outputs) to provide users with access to the full functionality of the application software executing on the server. Often, the users of the client devices remain unaware that their device is working in conjunction with an application server to provide the functionality.

Such client-server based systems may simplify software and device management by consolidating and centralizing computing resources (e.g., software, hardware, data resources, etc.). The client-server based systems may also enhance the user experience by providing the user with access to remotely stored data and a wide variety of complex functionality, some of which may exceed the computing power of their user equipment, while conserving battery life.

However, client-server based systems may be susceptible to certain types of malware and cyberattacks. In client-server architectures, conventional security solutions executing on the client computing devices may not be able to readily detect malware and cyberattacks. This is because the software functions in a distributed fashion, with the client device formulating function requests and the server performing the underlying operations of the software to generate an output or response back to the client device. As a result, the full functionality of a non-benign web-based application or cyberattack may not be readily apparent in any single computing device, system or network. Accordingly, new and improved security solutions that better protect client-server and network-based computing solutions may be beneficial to consumers in the near future.

### SUMMARY

Various embodiments include methods of protecting a computing device that may include monitoring inputs and outputs to a server computing device, deriving a functional specification based on the monitored inputs and outputs, and using the derived functional specification for anomaly detection. In some embodiments, using the derived functional specification for anomaly detection may include determining whether a behavior, activity, web application, process or software application program is non-benign. In some embodiments, the computing device may be the server computing device, in which case using the derived functional specification for anomaly detection may include determining whether the server computing device is under attack.

Some embodiments may further include constraining the functional specification with a generic constraint, detecting a new input-output pair (or request-response pair) based on the monitoring, determining whether the detected new input-output pair (or request-response pair) satisfies the constrained functional specification, and determining that the detected new input-output pair (or request-response pair) is anomalous in response to determining that the detected input-output pair (or request-response pair) satisfies the constrained functional specification.

Some embodiments may further include clustering outputs by similarity, generating an input cluster by clustering inputs that lead to the same output cluster, determining whether new inputs fit within the input cluster, and determining whether outputs associated with the new inputs fits in a corresponding output cluster. Such embodiments may further include determining whether the new inputs or the output associated with the new inputs fit any functional specification.

In some embodiments, deriving a functional specification based on the monitored inputs and outputs may include comparing input-output behavior against a commonly known functional specification.

Some embodiments may further include clustering input-output behavior into disjoint clusters on which program synthesis is applicable, applying program synthesis for each disjoint cluster to generate a black box of the functional specification, and synthesizing a software application program over the black box.

Some embodiments may further include collecting information from sensors deployed in the server computing device, and using the collected information to determine an application state, in which deriving the functional specification based on the monitored inputs and outputs further comprises deriving the functional specification based on the determined application state.

Further embodiments may include a computing device having a network transceiver and a processor configure to perform operations of the methods summarized above. Further embodiments may include a computing device having means for performing functions of the methods summarized above. Further embodiments may include non-transitory processor-readable media on which are stored processor-executable instructions configured to cause a processor of a computing device to perform operations of the methods summarized above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a communication system block diagram illustrating network components of an example network computing system that is suitable for use with various embodiments.

FIG. 1B is a block diagram illustrating components of an example system on chip that may be included in some embodiments computing device and configured to use multi-label classification or meta-classification techniques to classify benign, suspicious, and non-benign behaviors into categories, sub-categories, groups, or sub-groups in accordance with the various embodiments.

FIG. 2 is a block diagram illustrating example logical components and information flows in some embodiments of a behavior-based security solution that implements machine learning techniques.

FIG. 3 is a block diagram illustrating some embodiments security solution that implements machine learning techniques that account for causal relationships between inputs and outputs to better identify, detect, classify, model, prevent, and/or respond to cyberattacks and other the conditions or behaviors that could degrade a server or client computing device's performance, power utilization levels, network usage levels, security and/or privacy levels over time.

FIGS. 4 through 6 are process flow diagrams illustrating methods of protecting a computing device in accordance with various embodiments.

FIG. 7 is a component block diagram of a client computing device suitable for use in some embodiments.

FIG. 8 is a component block diagram of a service computing device suitable for use in some embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In overview, various embodiments provide methods, and computing devices (e.g., security appliance, etc.) configured to implement the methods, of automatically determining or inferring Input/Output (I/O) causal relationships, and using such causal relationships to generate a library of functional specifications. In various embodiments, the computing devices (e.g., security appliance, etc.) may be configured to use the I/O causal relationships or functional specifications for improved anomaly detection.

Due to continued improvements in network and communication technologies, certain distributed computing architectures (e.g., client-server architecture, multitenant software architectures used for cloud computing, etc.) are growing in popularity and use. Such systems may include any number of client devices, a server computing device (also referred to herein simply as a “server”), and a security appliance. The client devices may be configured to offload all or a portion of their operations to the server. The server may be configured to receive requests (input) from a client device, execute various functions or routines of a software application, generate an output, and send the generated output back to the requesting client device (e.g., for presentation to the user, etc.). The security appliance may be configured to monitor the communications and interactions between the server and client devices in order to identify malware and ensure that the server and client devices function correctly or as expected.

In some embodiments, the security appliance may be configured to implement and use machine learning techniques and behavior-based security solutions to perform anomaly detection operations. Such anomaly detection operations may include monitoring the communications and interactions between a client device and a server to collect behavior information, using the collected behavior information to generate a behavior vector information structure, generating or updating a machine learning classifier model (e.g., based on historical information, previous executions, prior classifications, etc.), applying the behavior vector information structure to a machine learning classifier model to generate analysis results, and using the generated analysis results to determine whether a behavior or activity of a networked computing device (e.g., the client or server device, etc.) may be classified as abnormal (or non-benign) with a sufficiently high degree of confidence.

The use of behavior-based machine learning techniques for anomaly detection may improve the performance of the security appliance. Yet, conventional behavior-based machine learning security solutions do not adequately account for the “causal relationships” between inputs and outputs.

When evaluated from a sufficiently high level of abstraction, most data-processing and computing systems share a common set of characteristics and perform a common set of generic operations. For example, most computing devices receive inputs, perform operations based on those inputs, and produce an output. The output is typically dependent on the input, and a causal relationship (or causality) exists between the input and the output. The causal relationship (“I/O causal relationship”) describes the effect, consequence or impact that a change in the input should have on its corresponding output. Any deviation from the causal relationship could be indicative of malware or other non-benign behaviors.

By automatically inferring the causal relationship between inputs and outputs, and using the inferred causal relationship for anomaly detection, various embodiments improve the accuracy, performance and functioning of a security appliance and/or a behavior-based security solution associated with the security appliance. Various embodiments may also improve the performance, functioning, efficiency, and security of the communication network and its constituent devices (e.g., client device, server device, a security appliance, etc.). In addition, various embodiments may improve the performance and functioning of distributed computing architectures, such as multitenant software architectures and client-server based systems in which the storage and execution of application software is moved from client devices to servers. Such client-server based systems may be deployed in a cloud communication network to enable ubiquitous on-demand access to a shared pool of commodity hardware, data storage facilities, and other computing resources.

The phrases “computing device,” “mobile computing device,” “client device” are used in this application to refer to any one or all of cellular telephones, smartphones, personal or mobile multi-media players, personal data assistants (PDAs), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar electronic devices that include a memory, a programmable processor, and communication resources that enable data communications with a remote server. The phrases “client device” and “computing device” may also refer to stationary computing devices, such as personal computers, desktop computers, embedded computers, all-in-one computers, workstations, super computers, mainframe computers, etc.

The phrases “not benign,” “non-benign,” “abnormal,” “performance-degrading” are used interchangeably in this application to refer to a wide variety of undesirable operations and characteristics of a network or computing device or server. Non-limiting examples of undesirable operations and characteristics include as longer processing times, slower real time responsiveness, lower battery life, loss of private, sensitive or unauthorized data, malicious economic activity (e.g., sending unauthorized premium short message service (SMS) messages), denial of service (DoS), poorly written or designed software applications, malicious software, malware, viruses, fragmented memory, injection flaws (e.g., Structured Query Language (SQL), operating system (OS), and Lightweight Directory Access Protocol (LDAP) injections that occur when untrusted data is sent to an interpreter/processor as part of a command or query), hostile data that tricks an interpreter/processor into executing unintended commands or accessing data without proper authorization, operations relating to commandeering the computing device or utilizing the device for spying or botnet activities, activities causing the leakage of an International Mobile Equipment Identity (IMEI) of the computing device, activities tracking the computing device's location, an unexpected or atypical connection for a particular type of communication, an unexpected or atypical connection for a particular application, communication activity typically associated with malware, communications with a nefarious server, etc. Also, behaviors, activities, and conditions that are abnormal or degrade performance for any of these reasons may be referred to in this application as “non-benign behaviors.”

The phrase “computing appliance” is used in this application to refer to a networked computing device or system that is configured with software, firmware and/or hardware to provide a specific computing resource or functionality, often to address a specific technical or engineering challenge. Unlike a general-purpose computer, a computing appliance typically does not allow the end user to modify or change the software, operating system, or hardware configuration after the appliance is installed or deployed into the network.

The phrase “security appliance” is used in this application to refer to a computing appliance that is deployed in a high-speed communication network and configured to monitor or observe network traffic, including the packets that are communicated between client devices and a server in a client-server system in which the storage and execution of application software is moved from the client device to the server. For example, a security appliance may include any or all of a firewall, a web application firewall (WAF), an intrusion detection system, a machine learning system, machine-learning based security solution, a behavior-based monitoring and analysis system, an anomaly detection system, an anomaly detector component, a functional specification learner component, and an application state element component. In various embodiments, the security appliance may be configured to perform various security-related operations that protect the network (or the client devices and/or servers connected to the network) from non-benign or performance-degrading behaviors. As part of the security-related operations, the security appliance may monitor, collect, analyze, group, cluster, label, mark, track and/or store any or all of the information that is communicated between a client device and a server. The security appliance may also collect and use inputs, outputs, application state elements, and/or relationship operators.

The phrase “application state elements” may be used in this application to refer to information or data that is internal to a computing device (e.g., a server) under evaluation. An application state element may be an information structure or unit that identifies an internal state of a computing device under evaluation. An application state element may include internal state information that is typically not stored by the server device (or computing device under evaluation) and not observable by a client device, but which affects the input or output. Examples of internal state information include User_Context and Session_ID.

The terms “input information,” “input,” and “inputs” may be used interchangeably in this application to refer to information or data that is sent from a client computing device to a server, and which is detectable or observable via a security appliance deployed in the network. Said another way, an input may be anything that a server receives from a client device, including any or all of the data included in any request messages sent to the server by the current client device, requests for a file, data sent to the server by other client devices, the current time, etc. Further examples of “input information” include communication messages (e.g., request/response messages, etc.), the content of communication messages, packets (e.g., request and response packets), the content of packets, intrinsic information (e.g., information included in packets headers, etc.), extrinsic information (e.g., temporal relationship information, etc.), and the like. An input may also be a sequence of key words, a file upload request, etc. In some embodiments, the input may be annotated with information about the request type and request context.

The terms “output information,” “output,” “outputs” may be used interchangeably in this application to refer to information or data that is sent from the server to the client (e.g., in response to inputs, etc.), and which is detectable or observable via a security appliance that is deployed in the network. Said another way, an output may be anything that the client device gets back from a server, including any or all of the data included in any response messages, the amount data, ordered elements, etc. Examples of “output information” include server response messages, packets, packet contents, intrinsic information, extrinsic information, and other similar information. The value of the output may be a list of pages related to the sequence of key words, a file download (e.g., at a much later period in time than the corresponding file upload request), etc. In some embodiments, the output may be annotated.

The phrase “input/output (′I/O′) relationship” may be used in this application to refer to a component, information structure, logic, procedure or function that defines or describes the relationships (e.g., causal relationship, temporal relationship, spatial relationship, etc.) between an input and its corresponding output.

The phrase “I/O causal relationship” may be used in this application to refer to a component, information structure, data model, algorithm, process, logic circuit, procedure or function that describes the effect or impact a change in input should have on its corresponding output. An I/O causal relationship may be a direct relationship or an indirect relationship. A direct I/O causal relationship may indicate that an increase or decrease in an input variable should cause the same or proportional changes (e.g., in values, size, data type, etc.) to occur in a corresponding output variable. An indirect I/O causal relationship may be any relationship that is not a direct relationship. For example, an indirect I/O causal relationship may indicate that an increase in the input variable should cause a decrease (or some other measurable and quantifiable change) in the output variable.

The phrase “functional specification” may be used in this application to refer to a component, information structure, data model, algorithm, process, state machine, logic circuit, logical formula, procedure, function, etc. that captures or describes a causal relationship (e.g., from a server point of view). A functional specification may also produce a series of “constraints.” A constraint may be an information structure or unit that evaluates a condition to generate a result that may be used to identify or detect a “deviation from causality” or “deviation from a causal relationship.” A constraint may include a test condition (or decision node, decision tree, etc.) and/or describe one or more values (e.g., an expected value, a sequence of values, a range of values, etc.) for one or more fields that are included in a packet header, the packet body (payload/contents), intrinsic information, extrinsic information, etc.

In some embodiments, the functional specification (or security appliance, computing device, etc.) may be configured to receive an input from a first endpoint, identify an output from a second endpoint that corresponds to the input, and generate a summary of the input-output pairs between the first and second endpoints. For example, the functional specification may receive a request packet (input) from a client device, identify a response packet (output) from a server device that corresponds to the request packet, and generate a summary of the request and response packets between the two endpoints. The functional specification may produce a series of “constraints” that may be checked against the next or subsequent packet that is received (i.e., either response or request) to determine whether there is a deviation from causality.

A functional specification may describe how certain input fields (e.g., from incoming requests, etc.) are associated with certain application elements (e.g., users, sessions, Internet Protocol (IP) addresses, etc.) and are then output (e.g., into an outgoing response, etc.). A functional specification may describe how certain inputs associate with an application state (or state of a digital logic circuit, state of a computer program, operating system state, device state, etc.), and how the application state affects the output. A functional specification may also describe how certain inputs (requests) affect certain outputs (responses), independent of whether a temporal relationship exists between the input and output. A functional specification may also relate inputs to outputs to application elements (e.g., in terms of information flows).

A functional specification can be implemented in multiple ways, including as a logical formula representing a conjunction of predicates over fields in packet headers and packet contents, as a hardware circuit, or as a software module. Depending on the exact representation, the functional specification would be evaluated by, respectively, a logic interpreter, a hardware scheduler to activate the appropriate circuit, or an event-dispatch mechanism to route packets to the appropriate software module.

In some embodiments, the security appliance may be configured to treat every network communication as a sequence of pairs of request and response packets, in which a client device endpoint sends a request packets and a server endpoint sends back a response packet. In some embodiments, the functional specification may be a construct that takes as input the current packet (either request or response), a summary of previous request and response packets between the same two endpoints, and produces a series of constraints that may be checked against the next packet following the current packet (i.e., either response or request). The constraints may be exact such as to detect any deviations from the expected packet. Such a constraint could describe an exact value for a field in a packet header or contents, or a small sequence or range of values.

In some embodiments, the security appliance may be configured to generate a summary of previous request and response packets (or an I/O summary). The security appliance may generate the summary (I/O summary) by extracting relevant fields from headers and contents of past request and response packets for a given pair of communicating endpoints, performing a statistical analysis over the sequence of fields to select an appropriate summary representation, and updating the summary for each relevant field. In some embodiments, the generated summary may be represented, for example, as a machine-learning model (constructed by clustering of field values), as a small set of valid values (constructed by collecting unique field values), or as mean and standard deviation values.

In some embodiments, the security appliance (or machine-learning based security solution) may be configured to use an I/O causal relationship to identify or determine the impact that a detected change or variation in input should have on the corresponding output. The security appliance may classify a behavior or activity as “abnormal” or “non-benign” in response to determining that the detected change or variation in input did not affect or impact the output as expected.

I/O causal relationships are often complex, and it may be challenging to identify and characterize such relationships repeatedly, in real-time, and/or without consuming an excessive amount of available resources (e.g., the network's available bandwidth resources, the computing device's available processing resources, etc.). Due to these and other challenges, existing machine learning solutions do not adequately, automatically or dynamically identify, determine or infer the common causal relationships between inputs and outputs. Existing solutions also do not use such causal relationships to identify, detect, classify, model, prevent, or respond to cyberattacks and other performance-degrading conditions or behaviors.

Various embodiments overcome the above-mentioned limitations of existing solutions by equipping computing devices (e.g., a security appliance, etc.) with a machine learning based security system that is configured to monitor communications between a client device and a server to collect I/O information, and use the collected I/O information to intelligently, dynamically and automatically infer, predict, identify, determine, compute, quantify or characterize the causal relationships between the inputs and the outputs. Various embodiments may also include computing devices that are configured to use the inferred causal relationships (or functional specifications that characterize the inferred causal relationships, etc.) to determine whether a deviation from causality has occurred. The computing device may determine that a deviation from causality has occurred by identifying known sequences or patterns or variations in the input.

Since any deviation from a causality may be a strong indication of an anomaly or non-benign behaviors, the computing device may use an identified deviation in order to focus local or remote security operations on evaluating suspicious behaviors and/or on more efficiently identify, classify and/or respond to performance-degrading device behaviors. For all the forgoing reasons, various embodiments improve the performance and functioning of computer networks, as well as the individual computing devices (e.g., servers) within the computer networks.

In various embodiments, a security appliance may be configured to collect I/O information by monitoring or observing network traffic between a client device and an application server (e.g., of a server computing device). The security appliance may analyze the collected I/O information to generate analysis results, and use the generated analysis results to protect the network (or the computing devices included in the network) from cyberattacks and other performance-degrading conditions or behaviors. For example, the security appliance may be configured to use the collected I/O information to automatically determine or infer (e.g., via machine learning techniques) causal relationships between the inputs and the outputs. The security appliance may also derive or generate functional specifications that characterize the inferred causal relationships, and store the functional specifications in memory. The security appliance may continue to monitor or observe network traffic to collect additional I/O information, compare the collected I/O information to the derived functional specifications to generate comparison results, and use the generated comparison results in conjunction with machine learning techniques to determine whether the collected I/O information is consistent with expected results (e.g., whether there are any deviations, etc.), whether a web application (e.g., an app invoked by a client device and supported by an application server, etc.) is exhibiting non-benign behavior, whether the client and/or server computing devices are functioning correctly or as expected, etc. The security appliance may also use the comparison results (or identified deviations) to identify or detect potential cyberattacks on the network, application server or any of the client computing devices in the network.

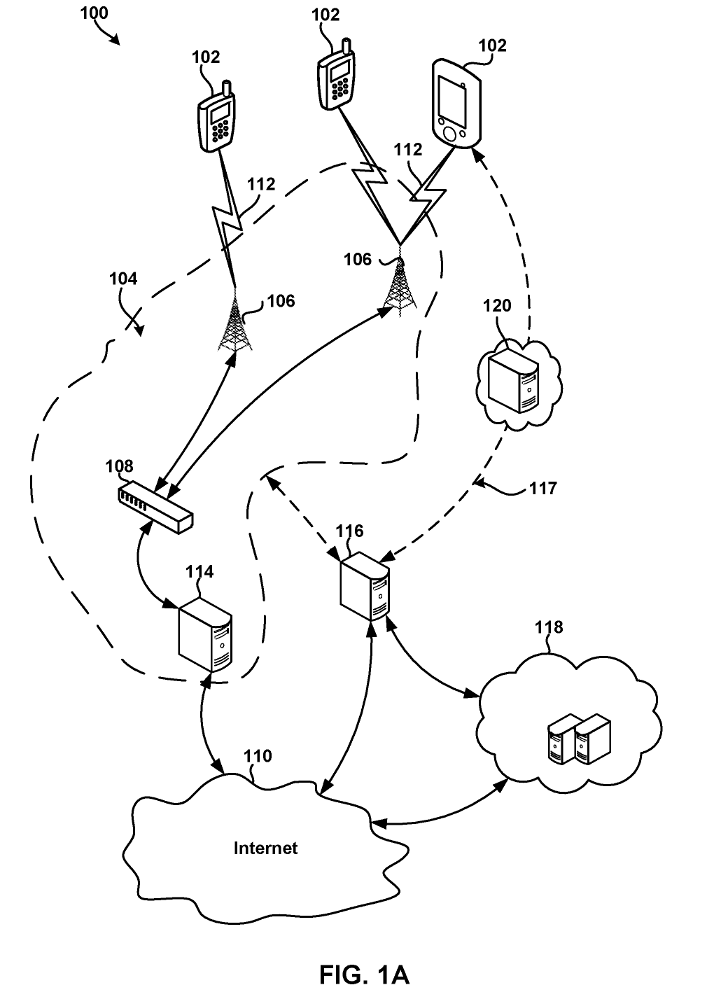

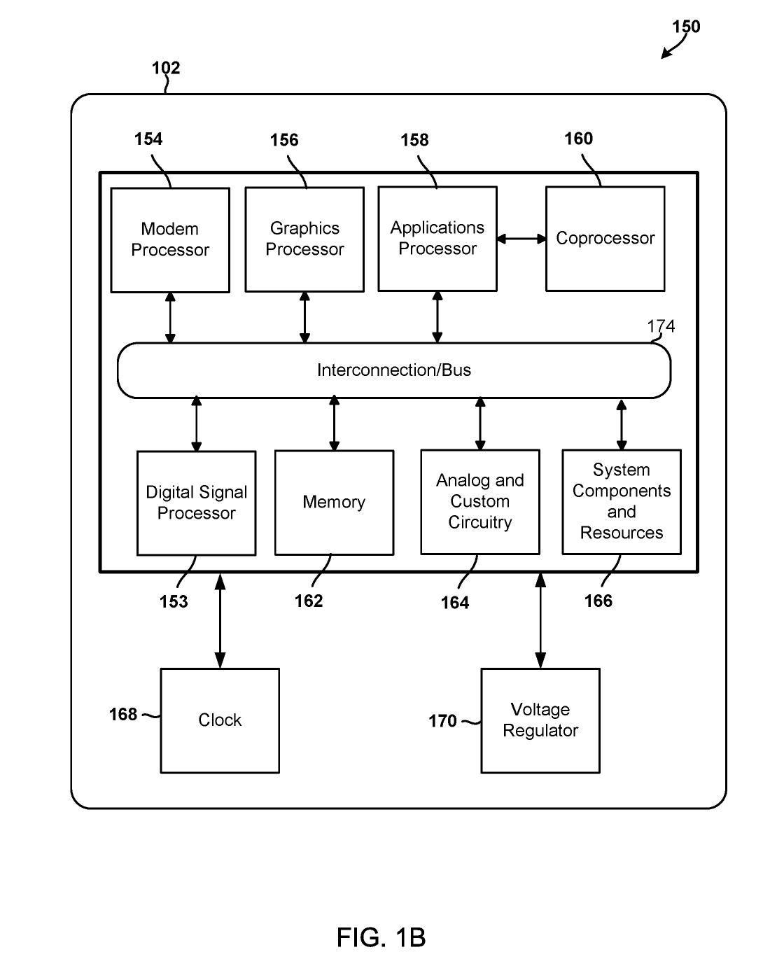

Various embodiments may be implemented within a variety of network communication systems, such as the example communication system 100 illustrated in FIG. 1A. A typical cell telephone network 104 includes a plurality of cell base stations 106 coupled to a network operations center 108, which operates to connect calls (e.g., voice calls or video calls) and data between client computing devices 102 (e.g., cell phones, laptops, tablets, etc.) and other network destinations, such as via telephone land lines (e.g., a plain old telephone service (POTS) network, not shown) and the Internet 110. Communications between the client computing devices 102 and the telephone network 104 may be accomplished via two-way wireless communication links 112, such as fourth generation (4G), third generation (3G), code division multiple access (CDMA), time division multiple access (TDMA), long term evolution (LTE) and/or other mobile communication technologies. The telephone network 104 may also include one or more servers 114 coupled to or within the network operations center 108 that provide a connection to the Internet 110.

The communication system 100 may further include network servers 116 connected to the telephone network 104 and to the Internet 110. The connection between the network servers 116 and the telephone network 104 may be through the Internet 110 or through a private network (as illustrated by the dashed arrows). A network server 116 may also be implemented as a server within the network infrastructure of a cloud service provider network 118. Communication between the network server 116 and the client computing devices 102 may be achieved through the telephone network 104, the internet 110, private network (not illustrated), or any combination thereof. In some embodiments, the network server 116 may be configured to establish a direct or indirect communication link 117 to the client computing device 102, and securely communicate information (e.g., requests, responses, etc.) via the communication link 117. For example, the server may be configured to receive inputs (e.g., data inputs, function requests, etc.) from a client computing device 102 via the communication link 117, apply the received inputs to the application software in order to cause the application software to execute various routines on the network server, capture the outputs generated via the execution of the routines, and send the outputs back to the client computing device 102 via the communication 117.

The communication system 100 may include a security appliance 120. The security appliance 120 may include a security system (e.g., behavior-based security system, anomaly detector, intrusion detection system, firewall, etc.) that is configured to monitor network traffic, such as the communications between the network server 116 and client computing device 102. The security appliance 120 may be further configured with processor executable software instructions to perform various security operations in order to protect the network (and the computing devices included the network) from non-benign behaviors, activities, or conditions. In some embodiments, the security appliance 120 may be equipped with a firewall component, an intrusion detection system, and/or an anomaly detection system. In some embodiments, all or portions of the security appliance 120 may be implemented via the network server 116. In some embodiments, all or portions of the security appliance 120 may be implemented via a client computing device 102.

In various embodiments, the client computing device 102, network server 116 and/or the security appliance 120 may include an on-device security system (e.g., behavior-based security system, anomaly detector, monitoring and analysis system, emulator, exerciser, detonator, etc.). The on-device security system may be configured to monitor and evaluate various conditions and device behaviors to identify and respond to the device behaviors that are abnormal or not benign, including device behaviors that are distributed between the network server 116 and client device 102 and/or software that functions in a distributed fashion (e.g., a client device formulating function requests and the server performing the underlying operations of the software to provide an output or response back to the client device). The on-device security system may generate machine learning classifier models (e.g., an information structure that includes component lists, decision nodes, etc.), generate behavior vectors (e.g., an information structure that characterizes a device behavior and/or represents collected behavior information via a plurality of numbers or symbols), apply the generated behavior vectors to the generated machine learning classifier models to generate an analysis result, and use the generated analysis result to classify the software application as benign or non-benign. In some embodiments, the on-device security system may also generate and use functional specifications for more accurate analysis results and/or to more accurately classify the software application as benign or non-benign (e.g., with a higher degree of confidence, etc.).

Various embodiments may be implemented on a number of single processor and multiprocessor computer systems, including a system-on-chip (SOC). FIG. 1B illustrates an example system-on-chip (SOC) 150 architecture that may be used in computing devices implementing the various embodiments, including any or all of the client computing device 102, network server 116, and security appliance 120 illustrated in FIG. 1A. With reference to FIG. 1B, the SOC 150 may include a number of heterogeneous processors, such as a digital signal processor (DSP) 153, a modem processor 154, a graphics processor 156, and an application processor 158. The SOC 150 may also include one or more coprocessors 160 (e.g., vector co-processor) connected to one or more of the heterogeneous processors 153, 154, 156, 158. Each processor 153, 154, 156, 158, 160 may include one or more cores, and each processor/core may perform operations independent of the other processors/cores. For example, the SOC 150 may include a processor that executes a first type of operating system (e.g., FreeBSD, LINUX, macOS, etc.) and a processor that executes a second type of operating system (e.g., Microsoft Windows 10, etc.).

The SOC 150 may also include analog circuitry and custom circuitry 164 for managing sensor data, analog-to-digital conversions, wireless data transmissions, and for performing other specialized operations, such as processing encoded audio and video signals for rendering in a web browser. The SOC 150 may further include system components and resources 166, such as voltage regulators, oscillators, phase-locked loops, peripheral bridges, data controllers, memory controllers, system controllers, access ports, timers, and other similar components used to support the processors and software clients (e.g., a web browser) running on a computing device.

The system components and resources 166 and/or custom circuitry 164 may include circuitry to interface with peripheral devices, such as cameras, electronic displays, wireless communication devices, external memory chips, etc. The processors 153, 154, 156, 158 may be interconnected to one or more memory elements 162, system components and resources 166, and custom circuitry 164 via an interconnection/bus module 174, which may include an array of reconfigurable logic gates and/or implement a bus architecture (e.g., CoreConnect, AMBA, etc.). Communications may be provided by advanced interconnects, such as high performance networks-on chip (NoCs).

The SOC 150 may further include another module (not illustrated in FIG. 1B) for communicating with resources external to the SOC, such as a clock 168 and a voltage regulator 170. Resources external to the SOC (e.g., clock 168, voltage regulator 170) may be shared by two or more of the internal SOC processors/cores (e.g., a DSP 153, a modem processor 154, a graphics processor 156, an applications processor 158, etc.).

In some embodiments, the SOC 150 may be included in a client device (e.g., client computing device 102 illustrated in FIG. 1A), which may be a mobile computing device such as a smartphone. A mobile computing device may include communication links for communications with a telephone network, the Internet, and/or a network server (e.g., network server 116 illustrated in FIG. 1A). Communications between the mobile computing device and the network server may be achieved through the telephone network, the Internet, a private network, or any combination thereof.

In various embodiments, the SOC 150 may be configured to collect behavioral, state, classification, modeling, success rate, and/or statistical information in the client computing device, and send the collected information to a network server or security appliance for analysis.

The SOC 150 may also include hardware and/or software components suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, etc.), cameras, compasses, Global Positioning System (GPS) receivers, communications circuitry (e.g., Bluetooth®, WLAN, WiFi, etc.), and other well-known components (e.g., accelerometer, etc.) of modern electronic devices.

In addition to the mobile computing device, client device and SOC 150 discussed above, the various embodiments may be implemented in a wide variety of computing systems, which may include a single processor, multiple processors, multicore processors, or any combination thereof.

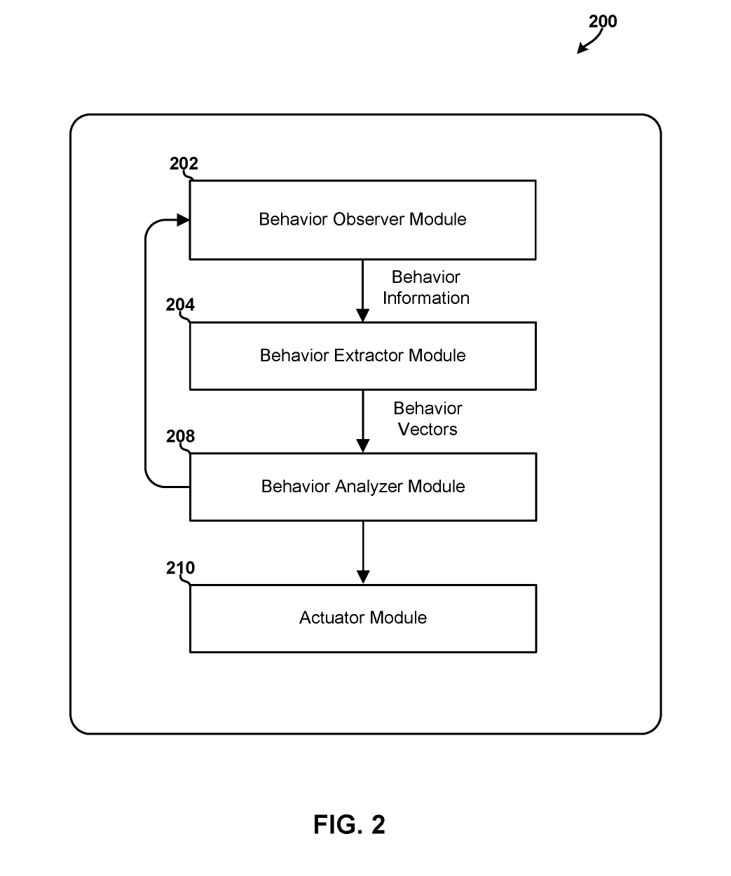

FIG. 2 illustrates example logical components and information flows in a computing device that includes a security system 200 that is configured to use machine learning and behavioral analysis techniques to identify and respond to non-benign device behaviors in accordance with some embodiments. In the example illustrated in FIG. 2, the computing device includes a device processor configured with executable instruction components or components, which include a behavior observer component 202, a behavior extractor component 204, a behavior analyzer component 208, and an actuator component 210. Each of the components 202-210 may be a thread, process, daemon, module, sub-system, or component that is implemented in software, hardware, or a combination thereof. In various embodiments, the components 202-210 may be implemented within parts of the operating system (e.g., within the kernel, in the kernel space, in the user space, etc.), within separate programs or applications, in specialized hardware buffers or processors, or any combination thereof. In some embodiments, one or more of the components 202-210 may be implemented as software instructions executing on one or more processors of the client computing device.

The behavior observer component 202 may be configured to instrument application programming interfaces (APIs), counters, hardware monitors, etc. at various levels/components of the device, and monitor the activities, conditions, operations, and events (e.g., system events, state changes, etc.) at the various levels/components over a period of time. For example, the behavior observer component 202 may be configured to monitor various software and hardware components of the client computing device, and collect behavior information pertaining to the interactions, communications, transactions, events, or operations of the monitored and measurable components that are associated with the activities of the client computing device. Such activities include a software application's use of a hardware component, performance of an operation or task, a software application's execution in a processing core of the client computing device, the execution of process, the performance of a task or operation, a device behavior, etc.

As a further example, the behavior observer component 202 may be configured to monitor the activities of the client computing device by monitoring the allocation or use of device memory by the software applications. In some embodiments, this may be accomplished by monitoring the operations of a memory management system (e.g., a virtual memory manager, memory management unit, etc.) of the computing device. Such systems are generally responsible for managing the allocation and use of system memory by the various application programs to ensure that the memory used by one process does not interfere with memory already in use by another process. Therefore, by monitoring the operations of the memory management system, the device processor may collect behavior information that is suitable for use in determining whether to two applications are working in concert, such as whether two processes have been allocated the same memory space, are reading and writing information to the same memory address or location, or are performing other suspicious memory-related operations.

The behavior observer component 202 may collect behavior information pertaining to the monitored activities, conditions, operations, or events, and store the collected information in a memory (e.g., in a log file, etc.). The behavior observer component 202 may then communicate (e.g., via a memory write operation, function call, etc.) the collected behavior information to the behavior extractor component 204.

The behavior extractor component 204 may be configured to receive or retrieve the collected behavior information, and use this information to generate one or more behavior vectors. In the various embodiments, the behavior extractor component 204 may be configured to generate the behavior vectors to include a concise definition of the observed behaviors, relationships, or interactions of the software applications. For example, each behavior vector may succinctly describe the collective behavior of the software applications in a value or vector data-structure. The vector data-structure may include series of numbers, each of which signifies a feature or a behavior of the device, such as whether a camera of the computing device is in use (e.g., as zero or one), how much network traffic has been transmitted from or generated by the computing device (e.g., 20 KB/sec, etc.), how many internet messages have been communicated (e.g., number of SMS messages, etc.), and/or any other behavior information collected by the behavior observer component 202. In some embodiments, the behavior extractor component 204 may be configured to generate the behavior vectors so that they function as an identifier that enables the computing device system (e.g., the behavior analyzer component 208) to quickly recognize, identify, or analyze the relationships between applications. In some embodiments, the behavior extractor component 204 may be configured to generate the behavior vectors to include information that may be input to a decision node in the machine learning classifier to generate an answer to a query regarding the monitored activity.

The behavior analyzer component 208 may be configured to apply the behavior vectors to classifier components to identify the nature of the relationship between two or more software applications. The behavior analyzer component 208 may also be configured to apply the behavior vectors to classifier components (e.g., full classifier models, lean classifier models, application-specific classifier models, etc.) to generate analysis results, and use the generated analysis results to determine whether a device behavior is a non-benign behavior that is contributing to (or is likely to contribute to) the device's degradation over time and/or which may otherwise cause problems on the device.

The behavior analyzer component 208 may notify the actuator component 210 that an activity or behavior is not benign. In response, the actuator component 210 may perform various actions or operations to heal, cure, isolate, or otherwise fix identified problems. For example, the actuator component 210 may be configured to stop or terminate one or more of the software applications when the result of applying the behavior vector to the classifier model (e.g., by the analyzer component) indicates that the collective behavior of the software applications not benign.

In some embodiments, the behavior observer component 202 may be configured to monitor the activities of the client computing device by collecting information pertaining to library application programming interface (API) calls in an application framework or run□time libraries, system call APIs, file□system and networking sub□system operations, device (including sensor devices) state changes, and other similar events. In addition, the behavior observer component 202 may monitor file system activity, which may include searching for filenames, categories of file accesses (personal info or normal data files), creating or deleting files (e.g., type exe, zip, etc.), file read/write/seek operations, changing file permissions, etc.

The behavior observer component 202 may also monitor the activities of the client computing device by monitoring data network activity, which may include types of connections, protocols, port numbers, server/client that the device is connected to, the number of connections, volume or frequency of communications, etc. The behavior observer component 202 may monitor phone network activity, which may include monitoring the type and number of calls or messages (e.g., SMS, etc.) sent out, received, or intercepted (e.g., the number of premium calls placed).

The behavior observer component 202 may also monitor the activities of the client computing device by monitoring the system resource usage, which may include monitoring the number of forks, memory access operations, number of files open, etc. The behavior observer component 202 may monitor the state of the client computing device, which may include monitoring various factors, such as whether the display is on or off, whether the device is locked or unlocked, the amount of battery remaining, the state of the camera, etc. The behavior observer component 202 may also monitor inter-process communications (IPC) by, for example, monitoring intents to crucial services (browser, contracts provider, etc.), the degree of inter-process communications, pop-up windows, etc.

The behavior observer component 202 may also monitor the activities of the client computing device by monitoring driver statistics and/or the status of one or more hardware components, which may include cameras, sensors, electronic displays, WiFi communication components, data controllers, memory controllers, system controllers, access ports, timers, peripheral devices, wireless communication components, external memory chips, voltage regulators, oscillators, phase-locked loops, peripheral bridges, and other similar components used to support the processors and clients running on the client computing device.

The behavior observer component 202 may also monitor the activities of the client computing device by monitoring one or more hardware counters that denote the state or status of the client computing device and/or computing device sub-systems. A hardware counter may include a special-purpose register of the processors/cores that is configured to store a count value or state of hardware-related activities or events occurring in the client computing device.

The behavior observer component 202 may also monitor the activities of the client computing device by monitoring the actions or operations of software applications, software downloads from an application download server (e.g., Apple® App Store server), computing device information used by software applications, call information, text messaging information (e.g., SendSMS, BlockSMS, ReadSMS, etc.), media messaging information (e.g., ReceiveMMS), user account information, location information, camera information, accelerometer information, browser information, content of browser-based communications, content of voice-based communications, short range radio communications (e.g., Bluetooth, WiFi, etc.), content of text-based communications, content of recorded audio files, phonebook or contact information, contacts lists, etc.

The behavior observer component 202 may also monitor the activities of the client computing device by monitoring transmissions or communications of the client computing device, including communications that include voicemail (VoiceMailComm), device identifiers (DeviceIDComm), user account information (UserAccountComm), calendar information (CalendarComm), location information (LocationComm), recorded audio information (RecordAudioComm), accelerometer information (AccelerometerComm), etc.

The behavior observer component 202 may also monitor the activities of the client computing device by monitoring the usage of, and updates/changes to, compass information, computing device settings, battery life, gyroscope information, pressure sensors, magnet sensors, screen activity, etc. The behavior observer component 202 may monitor notifications communicated to and from a software application (AppNotifications), application updates, etc. The behavior observer component 202 may monitor conditions or events pertaining to a first software application requesting the downloading and/or install of a second software application. The behavior observer component 202 may monitor conditions or events pertaining to user verification, such as the entry of a password, etc.

The behavior observer component 202 may also monitor the activities of the client computing device by monitoring conditions or events at multiple levels of the client computing device, including the application level, radio level, and sensor level. Application level observations may include observing the user via facial recognition software, observing social streams, observing notes entered by the user, observing events pertaining to the use of PassBook®, Google® Wallet, Paypal®, and other similar applications or services. Application level observations may also include observing events relating to the use of virtual private networks (VPNs) and events pertaining to synchronization, voice searches, voice control (e.g., lock/unlock a phone by saying one word), language translators, the offloading of data for computations, video streaming, camera usage without user activity, microphone usage without user activity, etc.

Radio level observations may include determining the presence, existence or amount of any or more of user interaction with the client computing device before establishing radio communication links or transmitting information, dual/multiple subscriber identification module (SIM) cards, Internet radio, mobile phone tethering, offloading data for computations, device state communications, the use as a game controller or home controller, vehicle communications, computing device synchronization, etc. Radio level observations may also include monitoring the use of radios (WiFi, WiMax, Bluetooth, etc.) for positioning, peer-to-peer (p2p) communications, synchronization, vehicle to vehicle communications, and/or machine-to-machine (m2m). Radio level observations may further include monitoring network traffic usage, statistics, or profiles.

The behavior analyzer component 208 may be configured to apply the behavior vectors generated by the behavior extractor component 204 to a classifier model to generate results that may be compared to a first and second thresholds (e.g., a low threshold of 0.1 and a high threshold of 0.9, etc.) in order to determine whether a monitored activity (or behavior, behavior vector, etc.) is benign or non-benign. In some embodiments, the behavior analyzer component 208 may classify a behavior as “suspicious” when the results of its behavioral analysis operations do not provide sufficient information to classify the behavior as either benign or non-benign (e.g., when the analysis result is 0.5 or falls between the first and second thresholds).

As an example, the client computing device may be configured to generate a lean classifier model (or a family of lean classifier models of varying levels of complexity) in the computing device based on a full or robust classifier model received from a server. The client computing device may generate behavior vectors, and apply the behavior vectors to the locally generated lean classifier model(s) in order to generate analysis results. The computing device may be compute a weighted average value (e.g., 0.4) of the analysis results. The computing device may classify the behavior as benign in response to determining that the weighted average value exceeds a first threshold (e.g., is less than 0.1). The computing device may classify the behavior as non-benign in response to determining that the weighted average value exceeds a second threshold (e.g., is greater than 0.9). The computing device may classify the behavior as suspicious in response to determining that the behavior does not exceed the first or second thresholds (i.e., the value of 0.4 is greater than the first threshold and less than the second threshold).

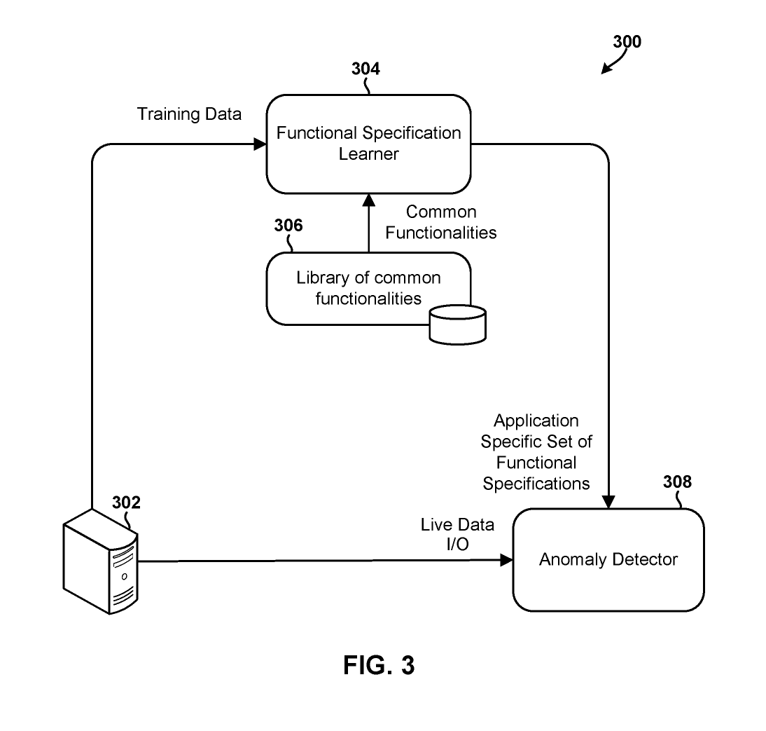

FIG. 3 illustrates an example system 300 that could be configured to use machine learning techniques that account for causal relationships between inputs and outputs (or between server requests and responses, etc.) in accordance with the various embodiments. In the example illustrated in FIG. 3, the system 300 includes a server computing device 302, a functional specification learner 304 component, a library of common functionalities 306 component, and an anomaly detector 308 component. Each of the components 304-308 may be a thread, process, daemon, module, sub-system, or component that is implemented in software, hardware, or a combination thereof. In some embodiments, component 304-308 may be implemented or included in the server computing device 302. In other embodiments, one or more of the component 304-308 may implemented or included in a client computing device (not illustrated in FIG. 3). In some embodiments, the anomaly detector 308 component may be implemented in a security appliance within a network.

The server computing device 302 may send training data to the functional specification learner 304 component. The functional specification learner 304 component may use the training data in conjunction with “common functionalities” received from the library of common functionalities 306 component to generate an application specific set of functional specifications (or a list of functional specification).

The anomaly detector 308 component may be configured to receive live data (e.g., real-time behavioral data, correlation information, etc.) and input/output information from the server computing device 302. Inputs may include any information that is visible to the client computing device, including data in any request sent in the past to the server computing device 302 by the current client computing device, any data sent to the server computing device 302 by other client devices, and the current time. In some embodiments, the inputs may also include annotation information that identifies a request type and request context. Outputs may include any information that is visible to the client computing device, including data that is received from the server computing device 302 by the current client computing device, the amounts and types of data (e.g., number of entries in an hypertext markup language (HTML) list) received from the server computing device 302, the order of elements in data received from the server computing device 302, etc.

The anomaly detector 308 component may also be configured to receive application specific set of functional specifications from the functional specification learner 304 component. A functional specification may include information that identifies how the inputs relate to application state (or application state elements), how inputs affect the output, a relationship operator, etc. The application state elements may include context (user, session, client IP address, and role), externally visible server information (response time, server IP address), state kept per context by the server (e.g., data stored on behalf of a user), etc. A relationship operator (e.g., “X˜>Y”) may indicate that an input (X) influences an output (Y) in measurable, definable, and specific ways. The inputs and outputs (X, Y) may also include references to data items or to metadata about data items (e.g., count, position in output, type).

The anomaly detector 308 component may be configured to use any of all of the received information to detect cyberattacks, determine whether the server computing device 302 is functioning correctly or as expected, or to improve the performance or functioning of the machine learning and/or behavior-based security system (e.g., the security system illustrated and described above with reference to FIG. 2).

The anomaly detector 308 component may be configured to receive a functional specification from the functional specification learner 304, monitor inputs and outputs to the server computing device 302, and repeatedly check to determine whether an I/O pair matches the functional specification.

The anomaly detector 308 may use derived functional specifications to do anomaly detection. The anomaly detector 308 may first constrain the functional specifications with “generic constraints” over application server operation, then use the constrained functional specifications to determine when new observed <request,response> pairs are anomalous (e.g., because they do not satisfy the constrained functional specification). As such, the anomaly detector 308 may accomplish early detection by evaluating the functional specification on an incoming request to determine how it will impact the server computing device 302.

As an example of generic constraints, for a multiuser application, data entered by one user should only be accessible to that user, unless shared. As further examples, sessions expire after some period of time, and users may have access only to data objects for which the server computing device 302 exposed a “pointer” in some past response.

In some embodiments, the anomaly detector 308 component may be configured to perform two-level anomaly detection using functional specifications. In the first level, the anomaly detector 308 component may perform anomaly detection on a functional specification, which may include clustering outputs by similarity, clustering inputs that lead to the same output cluster, checking whether a new input fits in an input cluster, and determining whether its corresponding output fits in an output cluster. In the second level, the anomaly detector 308 component may perform anomaly detection across the set of functional specifications. For example, the anomaly detector 308 may check whether new input and its output fit any one of the functional specifications.

In some embodiments, the anomaly detector 308 component may be configured to derive functionality by comparing I/O behavior against commonly known functional specifications. Examples of common functional specifications include data uploaded by user is stored and a pointer to it is returned for use in later retrieval, data uploaded by user is associated with an existing data item, data uploaded by user is appended to/replacing an existing data item, existing data item is deleted, existing data item is shared, etc.

In some embodiments, the anomaly detector 308 component may be configured to utilize program synthesis techniques. For example, the anomaly detector 308 component may cluster I/O behavior into disjoint clusters on which program synthesis is applicable, apply program synthesis for each disjoint cluster, and abstract the synthesized programs as “black boxes” of functional specifications. The anomaly detector 308 may repeat the process to synthesize a large or complex application program over the black boxes.

In some embodiments, the anomaly detector 308 component may be configured to learn and use application state information. For example, an I/O transformation may depend on application state. The anomaly detector 308 component may determine application state from sensors deployed on the server computing device 302 that is running the relevant application (e.g., inside the PHP: Hypertext Preprocessor (PHP) interpreter for a web application), and the application state may be used as another viable input for the inference of functional specifications. In some embodiments, the anomaly detector 308 component and/or the server computing device 302 may be configured to use state analysis algorithms, such as Daikon's invariant detection, to determine the application state. In some embodiments, the application state may be determined in the training phase, with the server sensors removed once the anomaly detector 302 is fully trained and ready to use in production.

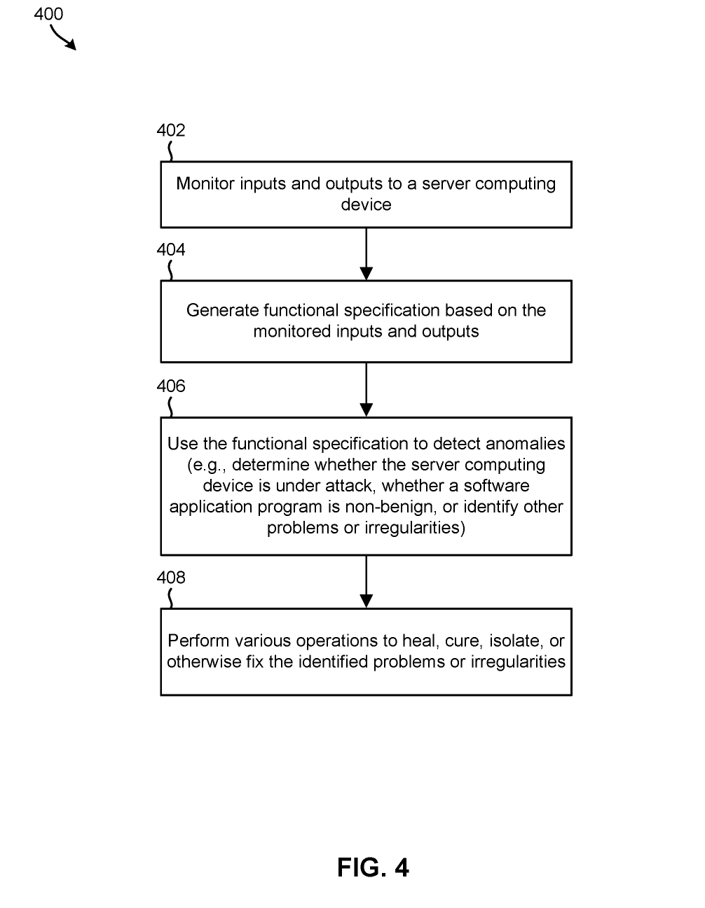

FIG. 4 illustrates a method 400 of protecting a computing device in accordance with some embodiments. With reference to FIGS. 1A-4, operations of the method 400 may be performed by a processor (e.g., 158) in a computing device, such as a security appliance.

In block 402, a processor in a computing device, such as a security appliance, may monitor inputs and outputs to a server computing device. In block 404, the processor may generate a functional specification based on the monitored inputs and outputs.

In block 406, the processor may use the functional specification to detect and/or identify anomalies (e.g., determine whether the server computing device is under attack, whether a software application program is non-benign, or identify other problems or irregularities, etc.).

In block 408, the processor may perform various operations to heal, cure, isolate, or otherwise fix any detected or identified problems or irregularities.

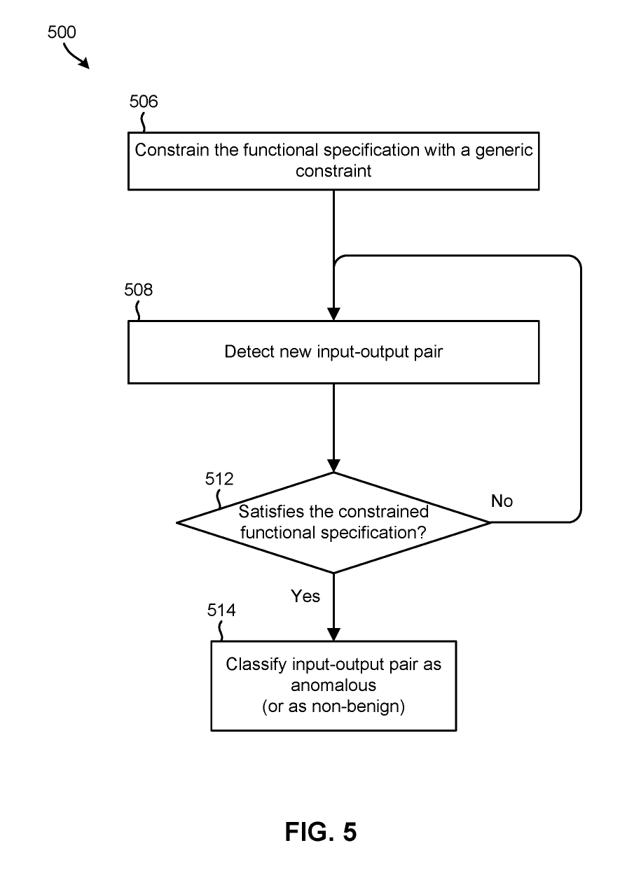

FIG. 5 illustrates a method 500 of protecting a computing device in accordance with some embodiments. With reference to FIGS. 1A-5, operations of the method 500 may be performed by a processor (e.g., 158) in a computing device, such as a security appliance.

In the method 500, a processor in a computing device may use the functional specification generated using the method 400 based on the monitored inputs and outputs as described. In block 506, the processor may constrain the functional specification with a generic constraint. For example, the processor may first constrain the functional specifications with “generic constraints” over application server operation, and later, use the constrained functional specifications to determine when new observed <request,response> pairs are anomalous (e.g., because they do not satisfy the constrained functional specification, etc.).

In block 508, the processor may detect a new input-output pair. In determination block 512, the processor may determine whether the identified input-output pair (or request-response pair) satisfies the constrained functional specification.

In response to determining that the identified input-output pair (or request-response pair) satisfies the constrained functional specification (i.e., determination block 512=“Yes”), the processor may determine that the identified input-output pair (or request-response pair) is anomalous in block 514.

In response to determining that the identified input-output pair does not satisfy the constrained functional specification (i.e., determination block 512=“No”), the processor may continue monitoring behaviors in block 402 and/or detect a new input-output pair in block 508.

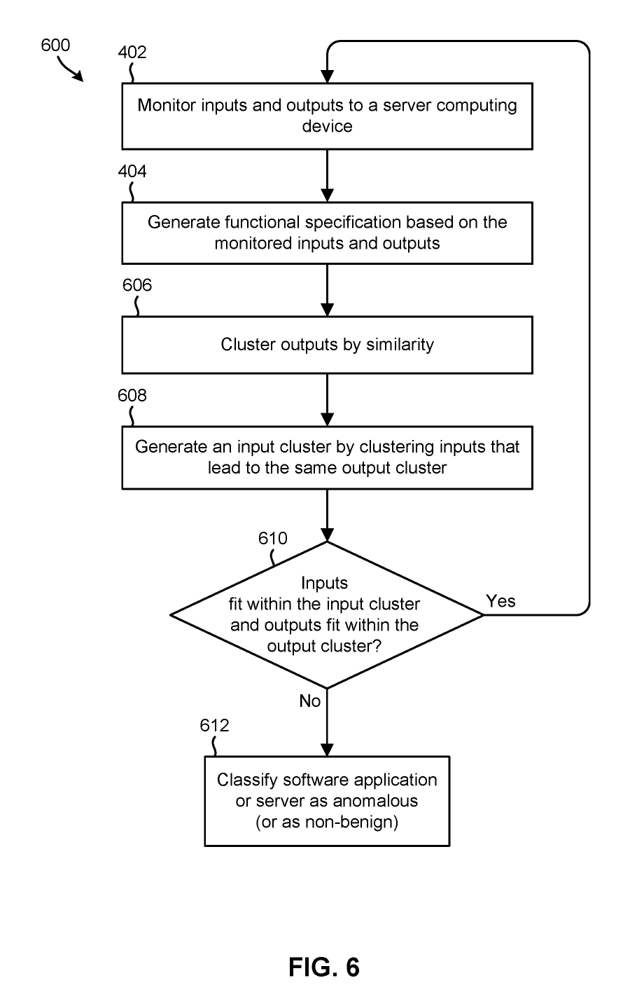

FIG. 6 illustrates a method 600 of protecting a computing device in accordance with some embodiments. With reference to FIGS. 1A-6, operations of the method 600 may be performed by a processor (e.g., 158) in a computing device, such as a security appliance. In blocks 402 and 404, a processor in a computing device may monitor inputs and outputs to the server computing device and generate a functional specification based on the monitored inputs and outputs as described. In block 606, the processor may cluster outputs by similarity. In block 608, the processor may generate an input cluster by clustering inputs that lead to the same output cluster.

In determination block 610, the processor may determine whether inputs fit within the input cluster and outputs fit within the corresponding output cluster.

In response to determining that inputs do not fit within the input cluster or outputs do not fit within the corresponding output cluster (i.e., determination block 610=“No”), the processor may classify the corresponding software application or server as anomalous or non-benign in block 612.

In response to determining that inputs fit within the input cluster and outputs fit within the corresponding output cluster (i.e., determination block 610=“Yes”), the processor may continue monitoring inputs and outputs in block 402.

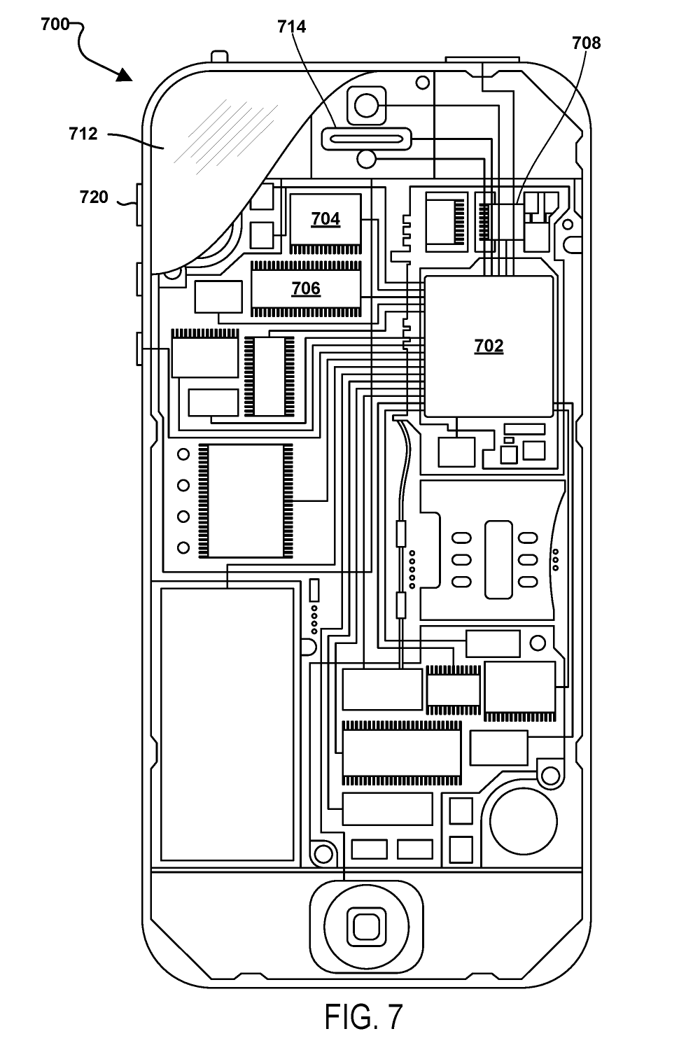

Various embodiments may be implemented on a variety of computing devices, an example of which is illustrated in FIG. 7 in the form of a smartphone. A smartphone 700 may include a processor 702 coupled to internal memory 704, a display 712, and to a speaker 714. Additionally, the smartphone 700 may include an antenna for sending and receiving electromagnetic radiation that may be connected to a wireless data link and/or cellular telephone transceiver 708 coupled to the processor 702. Smartphones 700 typically also include menu selection buttons or rocker switches 720 for receiving user inputs.

A typical smartphone 700 also includes a sound encoding/decoding (CODEC) circuit 706, which digitizes sound received from a microphone into data packets suitable for wireless transmission and decodes received sound data packets to generate analog signals that are provided to the speaker to generate sound. Also, one or more of the processor 702, wireless transceiver 708 and CODEC 706 may include a digital signal processor (DSP) circuit (not shown separately).

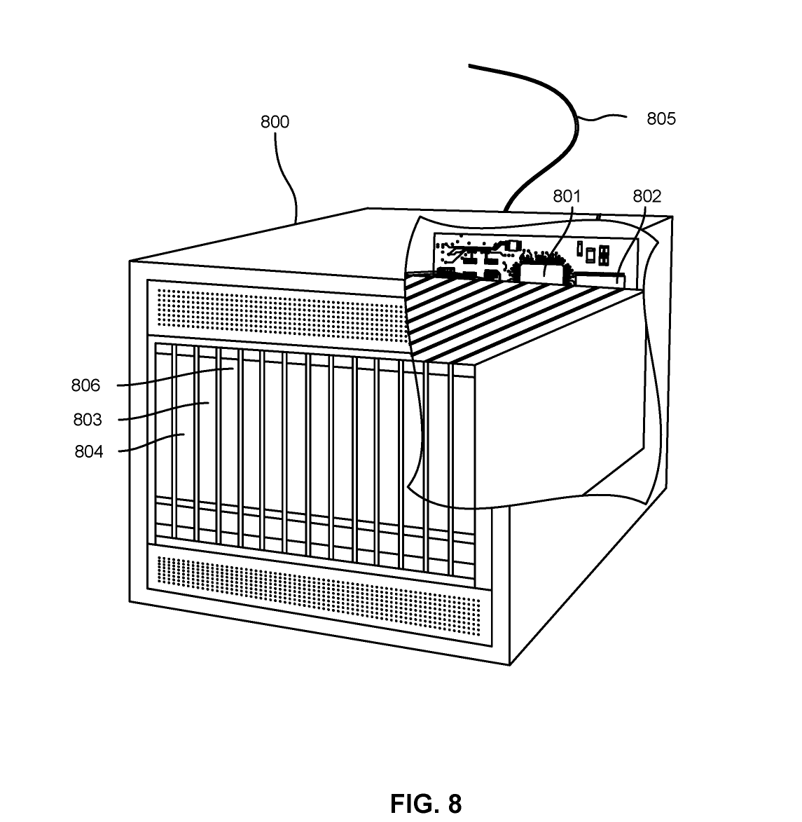

The embodiments and network servers described above may be implemented in variety of commercially available server devices, such as the server 800 illustrated in FIG. 8. Such a server 800 typically includes a processor 801 coupled to volatile memory 802 and a large capacity nonvolatile memory, such as a disk drive 803. The server 800 may also include a floppy disc drive, compact disc (CD) or DVD disc drive 804 coupled to the processor 801. The server 800 may also include network access ports 806 coupled to the processor 801 for establishing data connections with a network 805, such as a local area network coupled to other communication system computers and servers.

The processors 702, 801, may be any programmable microprocessor, microcomputer or multiple processor chip or chips that can be configured by software instructions (applications) to perform a variety of functions, including the functions of the various embodiments described below. In some client computing devices, multiple processors 702 may be provided, such as one processor dedicated to wireless communication functions and one processor dedicated to running other applications. Typically, software applications may be stored in the internal memory 704, 802, before they are accessed and loaded into the processor 702, 801. The processor 702 may include internal memory sufficient to store the application software instructions. In some servers, the processor 801 may include internal memory sufficient to store the application software instructions. In some receiver devices, the secure memory may be in a separate memory chip coupled to the processor 801. The internal memory 704, 802 may be a volatile or nonvolatile memory, such as flash memory, or a mixture of both. For the purposes of this description, a general reference to memory refers to all memory accessible by the processor 702, 801, including internal memory 704, 802, removable memory plugged into the device, and memory within the processor 702, 801 itself.

In various embodiments, a security appliance may be implemented via a variety of different configurations, such as via hardware, firmware, software, or a combination thereof. For example, in some embodiments, the security appliance may be implemented as a stand-alone computing device (or network device) within a network that includes a network monitoring circuit configured to receive and monitor network traffic without performing any further operations on such traffic. In some embodiments, the security appliance may be implemented as software functionality within a network server (e.g., a network security server, firewall, routing server), within an application server, within one or more client devices, or within a server client computing device. Any references to “security appliance” in this application are not intended to limit the scope of the specification or claims to any specific configuration or computing device unless expressly recited as such in the claims.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), global system for mobile communications (GSM), universal mobile telecommunications system (UNITS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iden). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many mobile computing devices operating system kernels are organized into a user space (where non-privileged code runs) and a kernel space (where privileged code runs). This separation is of particular importance in Android® and other general public license (GPL) environments where code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples, and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of protecting a computing device, comprising:
monitoring inputs and outputs to a server computing device;
deriving a functional specification based on the monitored inputs and outputs; and
using the derived functional specification for anomaly detection.

2. The method of claim 1, wherein using the derived functional specification for anomaly detection comprises:
determining whether a behavior, activity, web application, process or software application program is non-benign.

3. The method of claim 1,
wherein the computing device is the server computing device, and
wherein using the derived functional specification for anomaly detection comprises determining whether the server computing device is under attack.

4. The method of claim 1, further comprising:
constraining the functional specification with a generic constraint;
detecting a new input-output pair (or request-response pair) based on the monitoring;
determining whether the detected new input-output pair (or request-response pair) satisfies the constrained functional specification; and
determining that the detected input-output pair (or request-response pair) is anomalous in response to determining that the detected new input-output pair (or request-response pair) satisfies the constrained functional specification.

5. The method of claim 1, further comprising:
clustering outputs by similarity;
generating an input cluster by clustering inputs that lead to the same output cluster;
determining whether new inputs fit within the input cluster; and
determining whether outputs associated with the new inputs fits in a corresponding output cluster.

6. The method of claim 5, further comprising:
determining whether the new inputs or the output associated with the new inputs fit any functional specification.

7. The method of claim 1, wherein deriving a functional specification based on the monitored inputs and outputs comprises:
comparing input-output behavior against a commonly known functional specification.

8. The method of claim 1, further comprising:
clustering input-output behavior into disjoint clusters on which program synthesis is applicable;
applying program synthesis for each disjoint cluster to generate a black box of the functional specification; and
synthesizing a software application program over the black box.

9. The method of claim 1, further comprising:
collecting information from sensors deployed in the server computing device; and
using the collected information to determine an application state,
wherein deriving the functional specification based on the monitored inputs and outputs further comprises deriving the functional specification based on the determined application state.

10. A computing device, comprising:
a network transceiver; and
a processor coupled to the network transceiver and configure with processor-executable instructions to:
monitor inputs and outputs to a server computing device;
derive a functional specification based on the monitored inputs and outputs; and
use the derived functional specification for anomaly detection.

11. The computing device of claim 10, wherein the processor is further configured with processor-executable instructions to use the derived functional specification for anomaly detection to determine whether a behavior, activity, web application, process or software application program is non-benign.

12. The computing device of claim 10, wherein the computing device is the server computing device, and
wherein the processor is further configured with processor-executable instructions to use the derived functional specification to determine whether the server computing device is under attack.

13. The computing device of claim 10, wherein the processor is further configured with processor-executable instructions to:
constrain the functional specification with a generic constraint;
detect a new input-output pair (or request-response pair) based on the monitoring;
determine whether the detected new input-output pair (or request-response pair) satisfies the constrained functional specification; and
determine that the detected new input-output pair (or request-response pair) is anomalous in response to determining that the detected new input-output pair (or request-response pair) satisfies the constrained functional specification.

14. The computing device of claim 10, wherein the processor is further configured with processor-executable instructions to:
cluster outputs by similarity;
generate an input cluster by clustering inputs that lead to the same output cluster;
determine whether new inputs fit within the input cluster; and
determine whether outputs associated with the new inputs fits in a corresponding output cluster.

15. The computing device of claim 14, wherein the processor is further configured with processor-executable instructions to:
determine whether the new inputs or the output associated with the new inputs fit any functional specification.

16. The computing device of claim 10, wherein the processor is further configured with processor-executable instructions to derive a functional specification based on the monitored inputs and outputs by comparing input-output behavior against a commonly known functional specification.

17. The computing device of claim 10, wherein the processor is further configured with processor-executable instructions to:
cluster input-output behavior into disjoint clusters on which program synthesis is applicable;
apply program synthesis for each disjoint cluster to generate a black box of the functional specification; and
synthesize a software application program over the black box.

18. The computing device of claim 10, wherein the processor is further configured with processor-executable instructions to:
collect information from sensors deployed in the server computing device; and
use the collected information to determine an application state,
wherein the processor is further configured with processor-executable instructions to derive the functional specification based on the monitored inputs and outputs and on the determined application state.

19. A computing device, comprising:
means for monitoring inputs and outputs to a server computing device;
means for deriving a functional specification based on the monitored inputs and outputs; and
means for using the derived functional specification for anomaly detection.

20. A non-transitory processor-readable medium having stored thereon processor executable instructions configured to cause a processor of a computing device to perform operations comprising:
monitoring inputs and outputs to a server computing device;
deriving a functional specification based on the monitored inputs and outputs; and
using the derived functional specification for anomaly detection.

21. The non-transitory processor-readable medium of claim 20, wherein the stored processor executable instructions are further configured to cause the processor of the computing device to perform operations such that using the derived functional specification for anomaly detection comprises:
determining whether a behavior, activity, web application, process or software application program is non-benign.

22. The non-transitory processor-readable medium of claim 20, wherein the stored processor executable instructions are further configured to cause the processor of the computing device to perform operations such that using the derived functional specification for anomaly detection comprises determining whether the server computing device is under attack when the computing device is the server computing device.

23. The non-transitory processor-readable medium of claim 20, wherein the stored processor executable instructions are configured to cause the processor of the computing device to perform operations further comprising:
constraining the functional specification with a generic constraint;
detecting a new input-output pair (or request-response pair) based on the monitoring;
determining whether the detected new input-output pair (or request-response pair) satisfies the constrained functional specification; and
determining that the detected new input-output pair (or request-response pair) is anomalous in response to determining that the detected new input-output pair (or request-response pair) satisfies the constrained functional specification.

24. The non-transitory processor-readable medium of claim 20, wherein the stored processor executable instructions are configured to cause the processor of the computing device to perform operations further comprising:
clustering outputs by similarity;
generating an input cluster by clustering inputs that lead to the same output cluster;
determining whether new inputs fit within the input cluster; and
determining whether outputs associated with the new inputs fits in a corresponding output cluster.

25. The non-transitory processor-readable medium of claim 24, wherein the stored processor executable instructions are configured to cause the processor of the computing device to perform operations further comprising:
determining whether the new inputs or the output associated with the new inputs fit any functional specification.

26. The non-transitory processor-readable medium of claim 20, wherein the stored processor executable instructions are configured to cause the processor of the computing device to perform operations such that deriving a functional specification based on the monitored inputs and outputs comprises:
comparing input-output behavior against a commonly known functional specification.

27. The non-transitory processor-readable medium of claim 20, wherein the stored processor executable instructions are configured to cause the processor of the computing device to perform operations further comprising:
clustering input-output behavior into disjoint clusters on which program synthesis is applicable;
applying program synthesis for each disjoint cluster to generate a black box of the functional specification; and
synthesizing a software application program over the black box.

28. The non-transitory processor-readable medium of claim 20, wherein the stored processor executable instructions are configured to cause the processor of the computing device to perform operations further comprising:
collecting information from sensors deployed in the server computing device; and
using the collected information to determine an application state,
wherein deriving the functional specification based on the monitored inputs and outputs further comprises deriving the functional specification based on the determined application state.
